(19) United States
(12) Patent Application Publication
(10) Pub. No.: US 2025/0346299 A1
(43) Pub. Date: Nov. 13, 2025

(54) VEHICLE SIDE STRUCTURE

(71) Applicant: TOYOTA JIDOSHA KABUSHIKI KAISHA, Aichi-ken (JP)

(72) Inventors: Fumihiko KISHIMA, Konan-shi (JP); Kotaro SHIBATA, Toyoake-shi (JP)

(21) Appl. No.: 19/196,740

(22) Filed: May 2, 2025

(30) Foreign Application Priority Data
May 10, 2024 (JP) 2024-076903

(51) Int. Cl. B62D 25/18; B62D 37/02

(52) U.S. Cl. CPC B62D 25/18; B62D 37/02

(57) ABSTRACT

The vehicle side structure includes a fender having an outer opening at an upper portion thereof, a fender liner disposed inside the fender and covering an upper portion of the front wheel and having a liner opening at an upper portion thereof, and a duct connecting the liner opening and the outer opening and guiding air from the liner opening to the outer opening. The outer opening has first to fifth fender vanes and the duct has first to fifth duct vanes. The surfaces of the first to fifth fender vanes and the surfaces of the first to fifth duct vanes are disposed so as to be continuous in the flow direction.

### CROSS REFERENCE TO RELATED APPLICATION

This application claims priority to Japanese Patent Application No. 2024-076903 filed on May 10, 2024, which is incorporated herein by reference in its entirety including the specification, claims, drawings, and abstract.

### TECHNICAL FIELD

This disclosure relates to the structure of the fender on the side of a vehicle, the fender liner, and the duct that connects the fender liner and fender.

### BACKGROUND

JPA 2017-71289 discloses a vehicle body side structure including a front opening disposed on an upper portion of a fender of a vehicle, a rear opening disposed on a side surface of a body behind the fender, and a duct connecting the front opening and the rear opening, in which traveling wind in a wheel house flows from the front opening to the rear opening and flows out of the wheel house.

JPA 2005-289230 discloses an apparatus for suppressing diffusion of scattered matter that is provided around a wheel and prevents diffusion of pebbles and the like rolled up by the wheel.

### SUMMARY

In the structure described in JPA 2017-71289, since the traveling wind of the wheel house is caused to flow out to the side of the vehicle, there is a problem that the air resistance increases although the pressure inside the wheel house decreases and the downforce increases. In addition, there is a possibility that the small stones and the like rolled up by the wheels are scattered to the outside from the rear opening.

On the other hand, in a vehicle traveling at a high speed, a larger downforce is required. In addition, there is a need to suppress scattering of pebbles and the like rolled up by wheels to the outside.

Accordingly, an object of the present disclosure is to efficiently increase the downforce and to suppress the scattering of the pebbles or the like rolled up by the wheel to the outside.

A vehicle side structure according to an embodiment of the present disclosure includes a fender disposed on a side portion at the front of a vehicle and having an outer opening at an upper portion thereof, a fender liner disposed inside the fender and covering an upper portion of a front wheel, the fender liner having a liner opening disposed in an upper portion thereof so as to overlap the outer opening of the fender in a vehicle top view, and a duct that connects the liner opening of the fender liner and the outer opening of the fender and guides air from the liner opening to the outer opening. The fender includes a plurality of fender vanes disposed within the outer opening, the plurality of fender vanes are inclined toward the rear of the vehicle from a direction perpendicular to the ground, the duct includes a plurality of duct vanes extending in the same direction as the plurality of fender vanes, each of the plurality of fender vanes and each of the plurality of duct vanes are disposed such that an upper surface of each fender vane and an upper surface of each duct vane are continuous in a flow direction, and a lower surface of the fender vane and a lower surface of the duct vane are also continuous in the flow direction.

Accordingly, since the air flow in the wheel house is discharged to the outside along the upper surface of the fender, it is possible to suppress a decrease in the pressure of the upper surface of the fender and to reduce the pressure in the wheel house. Accordingly, the downforce can be increased. In addition, since the fender vanes and the duct vanes are inclined toward the rear of the vehicle from a direction perpendicular to the ground, it is possible to suppress scattering of the pebbles and the like rolled up by the front wheels to the outside.

In the vehicle side structure of the present disclosure, the plurality of fender vanes and the plurality of duct vanes may be arranged in a plurality of stages in a vehicle front-rear direction, in each of the plurality of fender vanes and each of the plurality of duct vanes in each stage, the upper surface of the fender vane and the upper surface of the duct vane may be continuous in a flow direction, whereas the lower surface of the fender vane and the lower surface of the duct vane may be continuous in the flow direction, and each of the plurality of duct vanes may be disposed such that each fender vane one stage ahead overlaps with each duct vane when viewed from a vehicle top front point.

As a result, the pebbles or the like wound up by the front wheel hits the duct vane, and the pebbles or the like does not hit the fender vane. Therefore, it is possible to suppress damage to the fender vane formed of the steel plate or the carbon-containing resin.

In the vehicle side structure of the present disclosure, the plurality of fender vanes and the plurality of duct vanes at the rear portion of the outer opening of the fender may be disposed such that the upper surface of each fender vane and the upper surface of each duct vane may be continuous in the flow direction, and the lower surface of the fender vane and the lower surface of the duct vane may be also continuous in the flow direction, and a front portion of the outer opening of the fender may communicate with a front compartment to discharge air from the front compartment to outside.

This can reduce the pressure in the front compartment and increase the downforce.

In the vehicle side structure of the present disclosure, at least one fender vane may be disposed at the front portion of the outer opening of the fender, the duct includes a cover portion that may cover a lower portion of the fender vane disposed at the front portion of the outer opening, and the cover portion may include a slit through which air from the front compartment flows.

As described above, since the cover portion covers the lower portion of the fender vane disposed at the front portion of the outer opening, the pebbles or the like wound up by the front wheel does not collide with the fender vane disposed at the front portion of the outer opening.

In the vehicle side structure of the present disclosure, each of the duct vanes may be made of resin or rubber.

Accordingly, it is possible to prevent the duct vane from being damaged or abnormal noise from being generated when the pebbles or the like rolled up by the front wheel collides with the duct vane.

According to the vehicle side structure of the present disclosure, it is possible to efficiently increase the down force and to suppress the scattering of the pebble or the like rolled up by the front wheel to the outside.

### BRIEF DESCRIPTION OF DRAWINGS

FIG. 1 is a perspective view showing a vehicle having a vehicle side structure according to an embodiment;

FIG. 2 is an exploded perspective view of a fender and a duct of the vehicle side structure shown in FIG. 1;

FIG. 3 is an exploded perspective view of a duct and a fender liner of the vehicle side structure shown in FIG. 1;

FIG. 4 is an elevational cross-sectional view of the vehicle side structure shown in FIG. 1, and is an A-A cross section shown in FIG. 1;

FIG. 5 is an explanatory view showing a flow of air and scattering of pebbles and the like when the vehicle having the vehicle side structure of the embodiment is traveling;

FIG. 6 is an elevational cross-sectional view illustrating a vehicle side structure according to another embodiment, and is a diagram illustrating a flow of air and scattering of pebbles and the like when a vehicle including the vehicle side structure according to another embodiment is traveling.

### DESCRIPTION OF EMBODIMENTS

Hereinafter, a vehicle side structure 10 according to an embodiment will be described with reference to the drawings. First, the vehicle 100 including the vehicle side structure 10 will be described. Note that FR, UP, and LH shown in the drawings indicate a front side, an upper side, and a left side of the vehicle 100, respectively. The opposite directions of FR, UP, and LH indicate the rear side, the lower side, and the right side. Hereinafter, in the case where the front-rear direction, the left-right direction, and the up-down direction are simply used, the front-rear direction, the left-right direction, and the up-down direction of the vehicle 100 are indicated unless otherwise specified. The front-rear, left-right, and up-down directions of the vehicle 100 are the front-rear, left-right, and up-down directions of the vehicle side structure 10. In the following description, the vehicle side structure 10 on the left side of the vehicle 100 will be described. Since the vehicle side structure on the right side of the vehicle is bilaterally symmetrical to the vehicle side structure 10 on the left side of the vehicle, description thereof will be omitted.

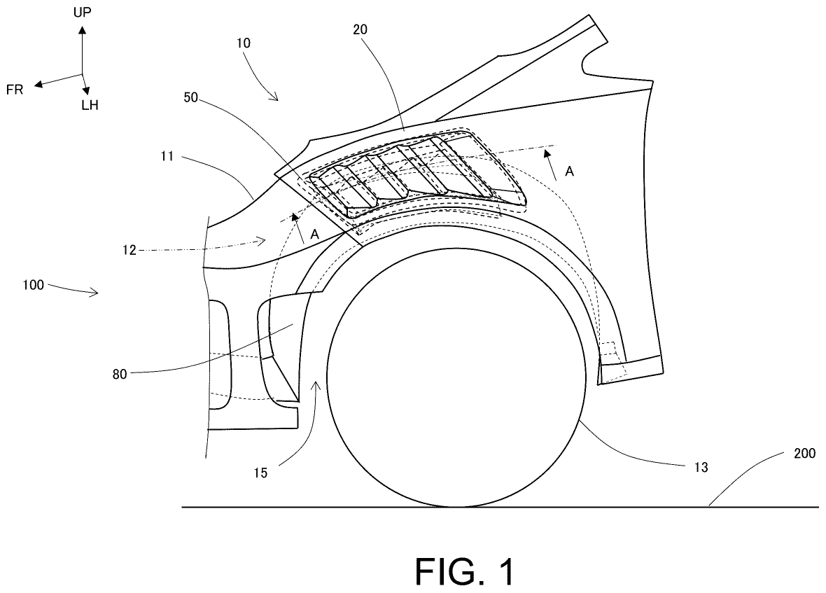

As shown in FIG. 1, the vehicle 100 includes a fender 20, a front bumper cover 11, a front compartment 12, a front wheel 13, a fender liner 80, and a duct 50. The fender 20 is a design panel that covers an area from an upper portion of the front wheel 13 of the front side portion of the vehicle 100 to the front door. The front bumper cover 11 is an exterior member that extends from the fender 20 to the front of the vehicle and covers a front bumper (not shown) disposed at the front of the vehicle. The front compartment 12 is a space disposed at the center in the vehicle width direction between the fender 20 and the front bumper cover 11. A drive mechanism such as an engine or a motor is mounted on the front compartment 12. The fender liner 80 is a plate member that is disposed inside the fender 20 and covers an upper portion of the front wheel 13. The fender liner 80 constitutes a part of the wheel house 15 that accommodates the front wheel 13 therein. A region below the fender liner 80 is the wheel house 15. The duct 50 is disposed between the fender liner 80 and the fender 20. The fender 20, the duct 50, and the fender liner 80 constitute the vehicle side structure 10.

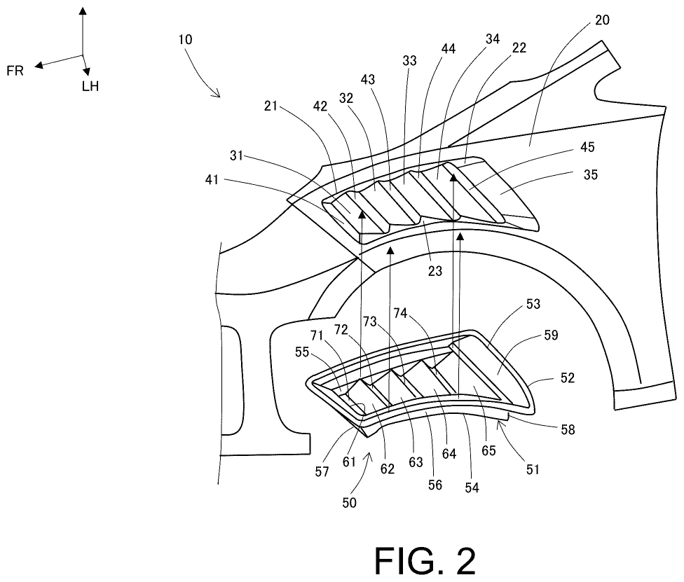

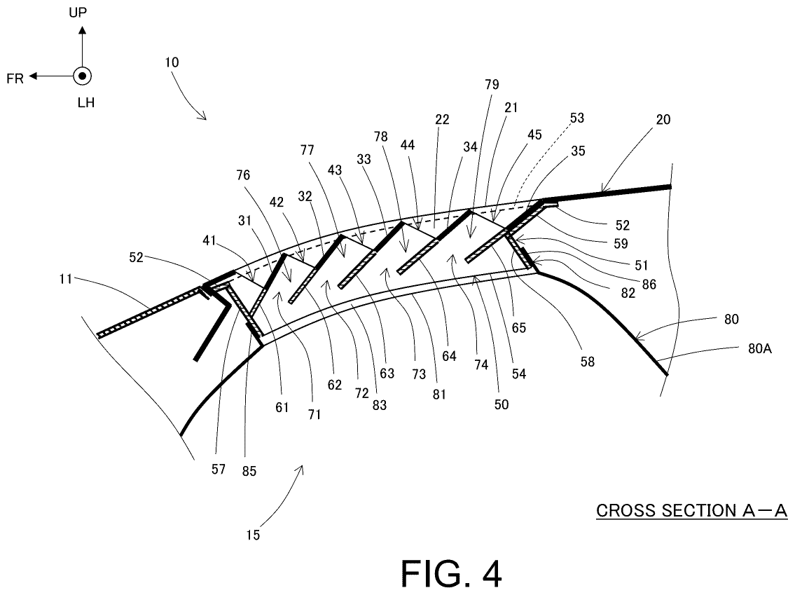

Next, the structures of the fender 20, the duct 50, and the fender liner 80 will be described in detail with reference to FIGS. 2 and 4.

First, the fender 20 will be described. As shown in FIG. 2, the fender 20 includes an outer opening 21, an inner opening wall 22, an outer opening wall 23, and first to fifth fender vanes 31 to 35. The outer opening 21 is disposed above the front wheel 13. The outer opening 21 is a substantially rectangular opening elongated in the vehicle front-rear direction. The inner opening wall 22 is a plate member extending downward from an inner edge of the outer opening 21 in the vehicle width direction. The outer opening wall 23 is a plate member extending downward from an outer edge of the outer opening 21 in the vehicle width direction. The first to fifth fender vanes 31 to 35 are plate members that connect the inner opening wall 22 and the outer opening wall 23 in the vehicle width direction. The first to fifth fender vanes 31 to 35 are arranged in a plurality of stages in the vehicle front-rear direction. The first fender vane 31 is disposed at the front of the vehicle, and the second fender vane 32 to the fifth fender vane 35 are disposed rearward from the front of the vehicle. The first to fifth fender vanes 31 to 35 may be formed of a steel plate or a carbon-containing resin.

As shown in FIG. 4, the first to fifth fender vanes 31 to 35 are inclined toward the rear of the vehicle from the vertical direction with respect to the ground 200 (see FIG. 1). The vehicle front edge of the outer opening 21 and the front end of the first fender vane 31 constitute a first air outlet 41. The rear end of the first fender vane 31 and the front end of the second fender vane 32 constitute a second air outlet 42. As described above, the rear ends of the first to fourth fender vanes 31 to 34 and the front ends of the second to fifth fender vanes 32 to 35 disposed on the rear side of the one-stage vehicle constitute the second to fifth air outlets 42 to 45, respectively. The rear end of the fifth fender vane 35 is connected to the vehicle rear edge of the outer opening 21. As shown in FIG. 4, the inner opening wall 22 has a shape in which a plurality of triangular plates surrounded by the inner edge of the outer opening 21, the lower surfaces of the first to fifth fender vanes 31 to 35, and the first to fifth air outlets 41 to 45 are arranged in the vehicle front-rear direction.

Next, the duct 50 will be described. As shown in FIGS. 2 and 4, the duct 50 includes a frame body 51, a flange 52, and the first to fifth duct vanes 61 to 65. The frame body 51 is a substantially rectangular annular member elongated in the vehicle front-rear direction. The frame body 51 includes an inner frame plate 55 on the vehicle width direction inner side, an outer frame plate 56 on the vehicle width direction outer side, a front frame plate 57 on the vehicle front side, a rear frame plate 58 on the vehicle rear side, and a rear upper frame plate 59. The inner peripheral edge of the upper end of the frame body 51 defines the outlet opening 53 of the duct 50. The outlet opening 53 is larger than the outer opening 21 of the fender 20. The inner peripheral edge of the lower end of the frame body 51 defines the inlet opening 54 of the duct 50. A flange 52 protruding outward from the outer peripheral surface of the frame body 51 is provided at the upper end of the frame body 51. The rear upper frame plate 59 is a plate member connecting the rear frame plate 58 and the flange 52, and is inclined toward the rear of the vehicle from the vertical direction with respect to the ground 200 (see FIG. 1).

The first to fifth duct vanes 61 to 65 are plate members that connect the inner frame plate 55 and the outer frame plate 56 in the vehicle width direction. The first to fifth duct vanes 61 to 65 are arranged in a plurality of stages in the vehicle front-rear direction. The first duct vane 61 is disposed at the front of the vehicle, and the second duct vane 62 to the fifth duct vane 65 are disposed rearward from the front of the vehicle. The first to fifth duct vanes 61 to 65 are made of resin or rubber.

As shown in FIG. 4, the first to fifth duct vanes 61 to 65 are inclined toward the rear of the vehicle from a direction perpendicular to the ground 200. Thus, the first to fifth duct vanes 61 to 65 extend in the same direction as the first to fifth fender vanes 31 to 35. The front end of the first duct vane 61 is connected to the front frame plate 57. The rear end of the first duct vane 61 and the front end of the second duct vane 62 constitute a first duct air outlet 71. As described above, the rear ends of the first to fourth duct vanes 61 to 64 and the front ends of the second to fifth duct vanes 62 to 65 disposed on the rear side of the one-stage constitute the first to fourth duct air outlets 71 to 74, respectively. The rear end of the fifth duct vane 65 is connected to the upper end of the rear frame plate 58.

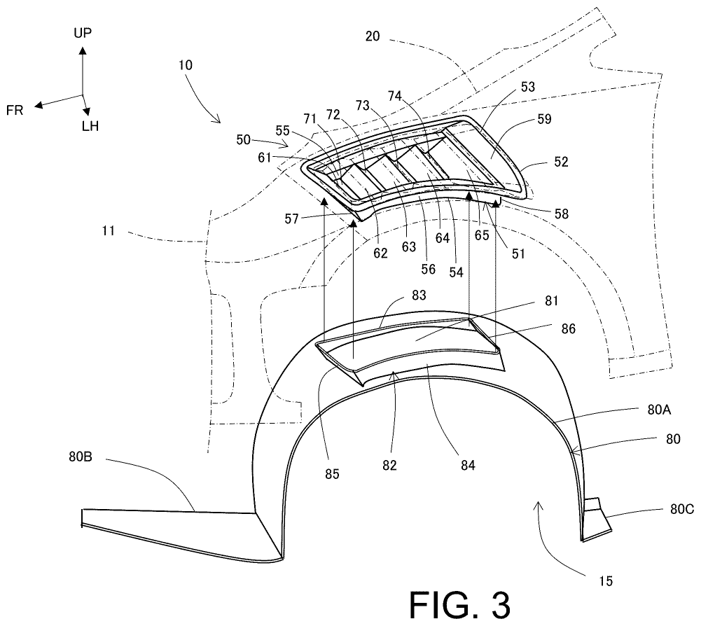

Next, the fender liner 80 will be described with reference to FIGS. 3 and 4. As shown in FIG. 3, the fender liner 80 includes an arc portion 80A, a front flange 80B, a rear flange 80C, and an opening frame 82. The arc portion 80A is an arc-shaped plate member that covers an upper portion of the front wheel 13. The front flange 80B is a flat plate portion extending in the vehicle front direction from a front lower end of the arc portion 80A. The front flange 80B covers the lower surface of the front bumper cover 11. The rear flange 80C is a flat plate portion that extends toward the vehicle rear side from the lower end on the rear side of the arc portion 80A. The rear flange 80C covers the lower end of the fender 20. A lower region of the arc portion 80A constitutes a wheel house 15 that accommodates the front wheel 13.

A liner opening 81 is provided in an upper portion of the arc portion 80A. The liner opening 81 is a substantially rectangular opening elongated in the vehicle front-rear direction. The liner opening 81 communicates with the wheel house 15. The dimension of the liner opening 81 is slightly larger than the outer dimension of the lower end of the frame body 51 of the duct 50. The opening frame 82 is a rectangular annular member erected on the outer peripheral edge of the liner opening 81. The opening frame 82 includes an inner plate 83 on the vehicle width direction inner side, an outer plate 84 on the vehicle width direction outer side, a front plate 85 on the vehicle front side, and a rear plate 86 on the vehicle rear side.

Assembly of the fender 20, the duct 50, and the fender liner 80 configured as described above will be described.

As indicated by arrows in FIG. 2, the duct 50 is assembled to the lower surface of the fender 20. As described above, the outlet opening 53 of the duct 50 is larger than the outer opening 21 of the fender 20, and the flange 52 of the duct 50 protrudes outside the outlet opening 53. Therefore, as shown in FIG. 4, the flange 52 of the duct 50 abuts against the lower surface of the outer peripheral edge of the outer opening 21 of the fender 20. The rear upper frame plate 59 of the duct 50 inclined toward the rear of the vehicle abuts against the lower surface of the fifth fender vane 35. When the flange 52 of the duct 50 is connected to the outer peripheral edge of the outer opening 21 of the fender 20, the rear ends of the first to fifth duct vanes 61 to 65 of the duct 50 are close to the front ends of the first to fifth fender vanes 31 to 35 of the fender 20.

Here, the first fender vanes 31 to 35 and the first duct vanes 61 to 65 are inclined toward the rear of the vehicle from a direction perpendicular to the ground 200. More specifically, the first to fifth duct vanes 61 to 65 are inclined toward the vehicle rear side at the same inclination angles as the first to fifth fender vanes 31 to 35, respectively. When the duct 50 is assembled to the lower surface of the fender 20, the upper surfaces of the first to fifth fender vanes 31 to 35 and the upper surfaces of the first to fifth duct vanes 61 to 65 are arranged side by side so as to be continuous in the inclination direction. At this time, the lower surfaces of the first to fifth fender vanes 31 to 35 and the lower surfaces of the first to fifth duct vanes 61 to 65 are also arranged side by side in the inclination direction. In this way, the first to fifth fender blades 31 to 35 and the first to fifth duct blades 61 to 65 arranged in the same stage are arranged so that the respective upper surfaces and the respective lower surfaces are continuous in the inclination direction.

In addition, the second to fifth duct vanes 62 to 65 vertically overlap the first to fourth fender vanes 31 to 34 one stage ahead. The second to fifth duct vanes 62 to 65 constitute first to fourth air flow paths 76 to 79 inclined toward the vehicle rear side together with the first to fourth fender vanes 31 to 34 one stage ahead.

As described above, the upper surfaces of the first to fifth fender vanes 31 to 35 are arranged side by side so as to be continuous with the upper surfaces of the first to fifth duct vanes 61 to 65 in the flow direction. The lower surfaces of the first to fifth fender vanes 31 to 35 are arranged side by side so as to be continuous with the lower surfaces of the first to fifth duct vanes 61 to 65 in the flow direction.

Next, when the fender liner 80 is assembled into the fender 20 as indicated by an arrow in FIG. 3, the opening frame 82 of the fender liner 80 fits into the outer circumference of the lower portion of the frame body 51 of the duct 50, as shown in FIG. 4. Thus, the fender liner 80 and the duct 50 are connected to each other.

As described above, when the fender 20, the duct 50, and the fender liner 80 are combined, the outer opening 21 of the fender 20 and the liner opening 81 of the fender liner 80 are disposed so as to overlap each other in a vehicle top view. The liner opening 81 is connected to the outer opening 21 of the fender 20 by the duct 50.

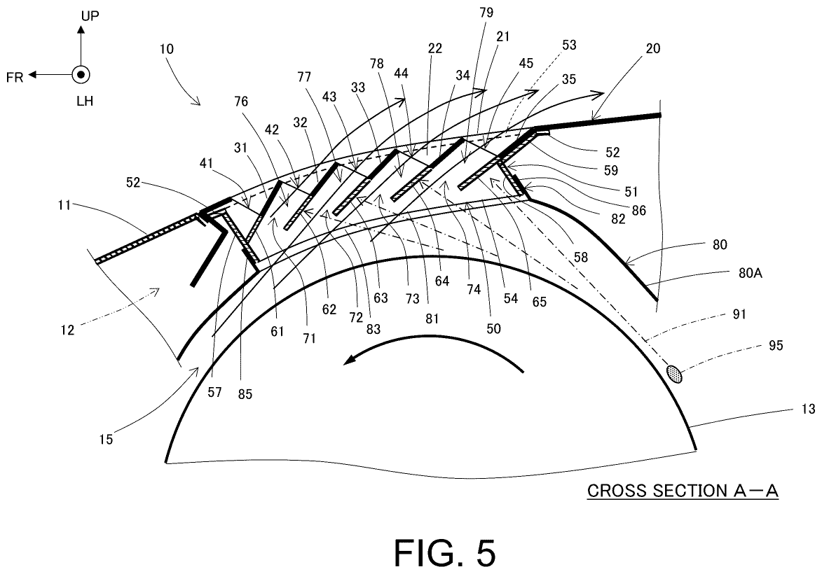

As indicated by an arrow in FIG. 5, while the vehicle 100 is traveling, the air in the wheel house 15 flows into the frame body 51 of the duct 50 from the liner opening 81 through the opening frame 82. Then, the air flowing into the frame body 51 passes through the first to fourth air flow paths 76 to 79 from the first to fourth duct air outlets 71 to 74 and is discharged to the outside from the second to fifth air outlets 42 to 45 of the fender 20. At this time, since the upper surfaces of the first to fifth fender vanes 31 to 35 and the upper surfaces of the first to fifth duct vanes 61 to 65 are arranged so as to be continuous in the flow direction, and the lower surfaces of the first to fifth fender vanes 31 to 35 and the lower surfaces of the first to fifth duct vanes 61 to 65 are arranged so as to be continuous in the flow direction, the air smoothly flows into the first to fourth air flow paths 76 to 79 from the first to fourth duct air outlets 71 to 74, and the air is discharged to the outside through the second to fifth air outlets 42 to 45. The air discharged to the outside flows rearward along the upper surface of the fender 20.

As described above, in the vehicle side structure 10, since the air in the wheel house 15 is discharged to the outside along the upper surface of the fender 20, it is possible to suppress a decrease in the pressure of the upper surface of the fender 20 and to reduce the pressure in the wheel house 15. Accordingly, the pressure difference between the pressure in the wheel house 15 and the pressure on the upper surface of the fender 20 can be increased, and the downforce can be increased.

Further, the pebble 95 rolled up by the front wheel 13 while the vehicle 100 is traveling is scattered obliquely upward in the front direction of the vehicle 100 along the tangential line of the outer circumference of the front wheel 13, as indicated by an arrow 91 indicated by a one-dot chain line in FIG. 5. That is, the pebble 95 scatters in a direction inclined toward the front of the vehicle from a direction perpendicular to the ground 200 (see FIG. 1). Here, the first to fifth fender vanes 31 to 35 and the first to fifth duct vanes 61 to 65 are inclined toward the rear of the vehicle from a direction perpendicular to the ground 200. Therefore, the first to fifth fender vanes 31 to 35 and the first to fifth duct vanes 61 to 65 extend in a direction intersecting the direction in which the pebble 95 is scattered. Therefore, the vehicle side structure 10 can prevent the pebble 95 rolled up by the front wheel 13 from scattering to the outside.

Further, since the second to fifth duct vanes 62 to 65 and the first to fourth fender vanes 31 to 34 are disposed so as to overlap in the scattering direction of the pebble 95, the pebble 95 rolled up by the front wheel 13 collides with the second to fifth duct vanes 62 to 65 and does not collide with the second to fourth fender vanes 31 to 34 made of a steel plate or a carbon-containing resin. Therefore, damage to the first to fourth fender vanes 31 to 34 made of a steel plate or a carbon-containing resin can be suppressed. In addition, since the second to fifth duct vanes 62 to 65 are made of resin or rubber, it is possible to suppress generation of abnormal noise when the pebble 95 collides with the duct vanes. Further, since the second to fifth duct vanes 62 to 65 are made of resin or rubber, they are not significantly damaged even when the pebble 95 collides.

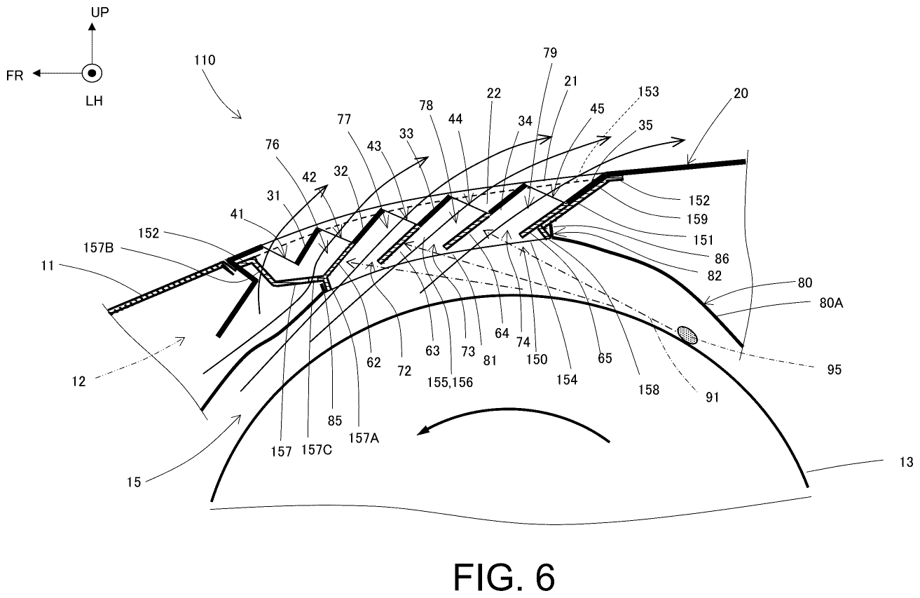

Next, a vehicle side structure 110 according to another embodiment will be described with reference to FIG. 6. The same parts as those of the vehicle side structure 10 described above with reference to FIGS. 1 to 5 are denoted by the same reference numerals, and description thereof is omitted.

As shown in FIG. 6, the vehicle side structure 110 includes a duct 150 instead of the duct 50 of the vehicle side structure 10. The fender 20 and the fender liner 80 are identical to the vehicle side structure 10. The frame body 151 of the duct 150 includes an inner frame plate 155, an outer frame plate 156, a front cover plate 157, a rear frame plate 158, and a rear upper frame plate 159. The height of the rear frame plate 158 is lower than that of the rear frame plate 58 of the duct 50, and the length of the rear upper frame plate 159 is longer than that of the rear upper frame plate 59 of the duct 50. The upper end of the frame body 151 is an outlet opening 153, and the lower end of the frame body 151 is an inlet opening 154.

The duct 150 does not include the first duct vane 61. The front cover plate 157 is an L-shaped plate member, and an upper end thereof is connected to the flange 152. A lower front frame plate 157A extending downward is connected to the lower end of the front cover plate 157. The lower end of the second duct vane 62 is connected to the lower end of the front cover plate 157. The front cover plate 157 constitutes a cover portion that covers the lower portion of the first fender vane 31 disposed at the front portion of the outer opening 21 of the fender 20.

The front cover plate 157 is provided with two slits 157B and 157C. The upper slit 157B communicates the first air outlet 41 of the fender 20 with the lower portion of the front bumper cover 11. The lower slit 157C communicates the first air flow path 76 with the lower portion of the front bumper cover 11. A lower portion of the front bumper cover 11 communicates with a front compartment 12 disposed on the back side of the drawing sheet. Accordingly, the slits 157B and 157C communicate the first air outlet 41 and the first air passage 76 with the front compartment 12.

As indicated by an arrow in FIG. 6, while the vehicle 100 is traveling, the air in the wheel house 15 flows into the frame body 151 of the duct 150 from the liner opening 81. Then, the air flowing into the frame body 151 passes through the second to fourth air flow paths 77 to 79 from the second to fourth duct air outlets 72 to 74 and is discharged to the outside from the third to fifth air outlets 43 to 45 disposed at the rear portion of the fender 20. The air discharged to the outside flows rearward along the upper surface of the fender 20. The duct 150 connects the liner opening 81 and the rear portion of the outer opening 21 of the fender 20, and guides air from the liner opening 81 to the rear portion of the outer opening 21.

While the vehicle 100 is traveling, the air in the front compartment 12 flows into the front portion of the outer opening 21 of the fender 20 through the lower portion of the front bumper cover 11, the slits 157B and 157C. The air flowing into the front portion of the outer opening 21 flows out from the first and second air outlets 41 and 42.

In addition to the effect of the vehicle side structure 10 described above, the vehicle side structure 110 can discharge the air in the front compartment 12 to the outside, reduce the pressure in the front compartment 12, and further increase the downforce.

1. A vehicle side structure, comprising:
a fender disposed on a side portion at the front of a vehicle and having an outer opening at an upper portion thereof,
a fender liner disposed inside the fender and covering an upper portion of a front wheel, the fender liner having a liner opening disposed in an upper portion thereof so as to overlap the outer opening of the fender in a vehicle top view, and
a duct that connects the liner opening of the fender liner and the outer opening of the fender and guides air from the liner opening to the outer opening,
wherein the fender includes a plurality of fender vanes disposed within the outer opening,
the plurality of fender vanes are inclined toward the rear of the vehicle from a direction perpendicular to the ground,
the duct includes a plurality of duct vanes extending in the same direction as the plurality of fender vanes,
each of the plurality of fender vanes and each of the plurality of duct vanes are disposed such that an upper surface of each fender vane and an upper surface of each duct vane are continuous in a flow direction, and a lower surface of the fender vane and a lower surface of the duct vane are also continuous in the flow direction.

2. The vehicle side structure according to claim 1, wherein
the plurality of fender vanes and the plurality of duct vanes are arranged in a plurality of stages in a vehicle front-rear direction,
in each of the plurality of fender vanes and each of the plurality of duct vanes in each stage, the upper surface of the fender vane and the upper surface of the duct vane are continuous in a flow direction, whereas the lower surface of the fender vane and the lower surface of the duct vane are continuous in the flow direction,
each of the plurality of duct vanes is disposed such that each fender vane one stage ahead overlaps with each duct vane when viewed from a vehicle top front point.

3. The vehicle side structure according to claim 1, wherein
the duct connects the liner opening of the fender liner and a rear portion of the outer opening of the fender, and guides air from the liner opening to the rear portion of the outer opening,
the plurality of fender vanes and the plurality of duct vanes at the rear portion of the outer opening of the fender are disposed such that the upper surface of each fender vane and the upper surface of each duct vane are continuous in the flow direction, and the lower surface of the fender vane and the lower surface of the duct vane are also continuous in the flow direction, and
a front portion of the outer opening of the fender communicates with a front compartment to discharge air from the front compartment to outside.

4. The vehicle side structure according to claim 2, wherein
the duct connects the liner opening of the fender liner and a rear portion of the outer opening of the fender, and guides air from the liner opening to the rear portion of the outer opening,
the plurality of fender vanes and the plurality of duct vanes at the rear portion of the outer opening of the fender are disposed such that the upper surface of each fender vane and the upper surface of each duct vane are continuous in the flow direction, and the lower surface of the fender vane and the lower surface of the duct vane are also continuous in the flow direction, and
a front portion of the outer opening of the fender communicates with a front compartment to discharge air from the front compartment to outside.

5. The vehicle side structure according to claim 3, wherein
at least one fender vane is disposed at the front portion of the outer opening of the fender,
the duct includes a cover portion that covers a lower portion of the fender vane disposed at the front portion of the outer opening, and
the cover portion includes a slit through which air from the front compartment flows.

6. The vehicle side structure according to claim 4, wherein
at least one fender vane is disposed at the front portion of the outer opening of the fender,
the duct includes a cover portion that covers a lower portion of the fender vane disposed at the front portion of the outer opening, and
the cover portion includes a slit through which air from the front compartment flows.

7. The vehicle side structure according to claim 3, wherein
each of the plurality of duct vanes is made of resin or rubber.

8. The vehicle side structure according to claim 4, wherein
each of the plurality of duct vanes is made of resin or rubber.
